(19) United States
(12) Patent Application Publication
(10) Pub. No.: US 2002/0049005 A1
(43) Pub. Date: Apr. 25, 2002

(54) Electrical high-current connection device

(75) Inventor: Ludger Leve, Rahden (DE)

Correspondence Address: Norman P. Soloway, HAYES, SOLOWAY, HENNESSEY, GROSSMAN & HAGE, P.C., 175 Canal Street, Manchester, NH, 03101, US

(73) Assignee: Harting Automotive GmbH & Co. KG

(21) Appl. No.: 09/935,851

(22) Filed: Aug. 23, 2001

(30) Foreign Application Priority Data
Aug. 24, 2000 (DE) 100 41 516.4

(51) Int. Cl. H01R 13/05

(52) U.S. Cl. 439/825

(57) ABSTRACT

The invention relates to an electrical high-current connection device comprising a receptacle for an electrical conductor to which conductor the connection device is to be permanently fastened. The device farther comprises an elastic plug contact for being connected with a counterplug. The receptacle and the plug contact are formed of separate parts which are non-detachably fastened to each other.

### TECHNICAL FIELD

The invention relates to an electrical high-current connection device.

### BACKGROUND OF THE INVENTION

One field of application of such electrical connection devices, for example, is to be found in the field of automotive engineering. They serve to connect, for instance, a generator or a starting motor. The high strength of currents which have to be transferred here may amount to up to 400 A, if, for example, the starting motor and the generator are combined into an integrated component. Electrical connection devices which transfer high currents and are coupled with associated conductors with cross-sections of 35 mm2 and above, will be more and more important in the future, because e.g. in the automotive field there will exist more and more electrically driven components which hitherto have been mechanically driven directly by the engine.

The electrical connection devices for making contact at high strength of currents should therefore be easy to plug and, nevertheless, guarantee a safe contact over decades.

### BRIEF SUMMARY OF THE INVENTION

It is, therefore, the object of the invention to provide an electrical connection device which can be reliably and permanently fastened to the electrical connector in an easy manner, whilst still being able to reliably transfer high currents for years.

This is achieved in an electrical connection device which comprises a receptacle for an electrical conductor to which conductor the connection device is to be permanently fastened. The device further comprises an elastic plug contact for being connected with a counterplug. The receptacle and the plug contact are formed of separate parts which are non-detachably fastened to each other by a fastener. The connection device proposed allows a better adaptation of connection and plug contacts to the demands which are made on them and partially are conflicting. The receptacle, for instance, should be made of a relatively soft, deformable material, in order to be able to be pressed on the electrical conductor. A plug contact which is formed of a soft and easily deformable material, however, may be plastically deformed already when being inserted into the counterplug, or it may be permanently deformed in the course of the years due to settling processes, so that a safe contact is not ensured. In the connection device according to the invention, however, the receptacle and the plug contact are able to be optimally adapted to the requirements being characteristic to them, without this being at the expense of the function of the respective other part.

The receptacle and the plug contact, for example, may be manufactured from different materials or be produced by different methods of manufacturing, this reducing the costs for the connection device as a whole. The receptacle and the plug contact may be manufactured from a material with a various heat-treatment or differing thickness, for example. The non-detachable fastener, i.e. a fastener detachable only by destroying, makes sure a permanent coupling of the two parts. The fastener is preferably such that a movement of the parts relative to each other is not permitted, for ensuring the safeness of the contact.

According to one design of the invention the receptacle and the plug contact have end walls axially adjoining each other directly or indirectly. A rivet joint engages on the end walls and exerts a force on the end walls which strives for moving the end walls towards each other. So the end walls may either directly adjoin each other and consequently have a large contact surface area, or a part may be provided between the end walls so as to be clamped through them, with a large contact surface area being provided here, too.

According to the preferred embodiment, the rivet is a protrusion integrally formed on an end wall and projecting through an opening in the other end wall, the rivet being deformed at its free end; thus, no separate additional part will be necessary for establishing the connection.

This protrusion, in its non-pressed state, is preferably hollow and cylindrical, for providing a sort of full tubular rivet joint which is distinguished by low deformation forces during setting the rivet.

A holding sleeve, including a means for latching the connection device in the counterplug, may optionally be part of the connection device, for preventing a decoupling of connection device and counterplug. The holding sleeve usually surrounds the receptacle. The holding sleeve, too, may be made of a material optimally adapted to the demand made on it, e.g. a steel with good elastic properties.

In order to reduce the number of connections, the holding sleeve, when designed as a separate part, may likewise be non-detachably fastened to the receptacle and the plug contact by the already mentioned connection between these parts, for example by disposing the holding sleeve between the mentioned end walls, so that the sleeve is clamped by the end walls. This design also has the advantage that a sort of modular concept is realized, because the receptacle and the plug contact can be designed so as to be identical, independently of whether the holding sleeve is clamped between them or not.

In case the plug contact and/or the receptacle are designed cup-shaped, they preferably are manufactured by deep-drawing or extrusion, i.e. a very cost-effective method.

The plug contact has radially elastically flexible platelets for establishing a safe connection which, however, can be coupled in an easy manner.

These platelets have a free end, and with these ends directed forwards, the connection device according to the invention is inserted into the counterplug. A safe contact-making and an easy plugging-in is possible, if the free ends have a section which is bent radially outwards and preferably runs radially inwards again, as seen towards the free end.

The free ends of the platelets complement each other to form a section of a spherical cap.

The sections bent outwards are produced e.g. by stamping, which is likewise a lowcost method of manufacturing.

### BRIEF DESCRIPTION OF THE DRAWINGS

FIG. 1 is a longitudinal sectional view of an electrical connection device according to the invention,

FIG. 2 is a scaled-down side view of the connection device of FIG. 1,

FIG. 3 is a perspective view of the receptacle provided in the connection device of FIG. 1, and of the plug contact in the not yet fastened state,

FIG. 4 is a punched sheet metal, from which the plug contact of FIG. 3 is produced through further deforming,

FIG. 5 is a punched sheet metal, from which the holding sleeve to be seen in FIG. 1 is produced through further deforming,

FIG. 6 is a perspective view of the finished holding sleeve.

### DETAILED DESCRIPTION OF THE PREFERRED EMBODIMENT

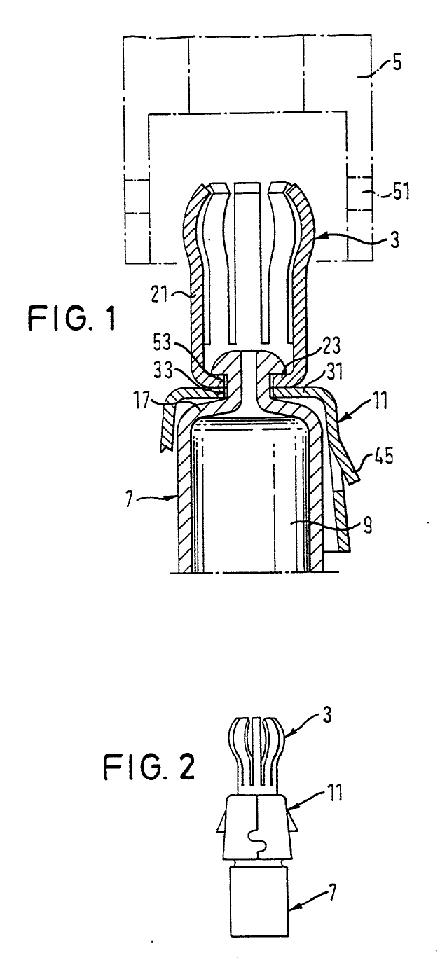

In FIG. 1 there is illustrated a high-current connection device, which consists of three parts, namely an elastic plug contact 3 which is inserted into a counterplug 5 illustrated in dash-and-dot lines, a receptacle 7 which is placed on an end of an electrical conductor 9 and is permanently fastened to it by crimping, and a holding sleeve 11.

The connection device is intended to be used for making contact at high currents, in which the electrical conductor has a cross-sectional area of 50 to 70 mm².

The connection device itself is designed as a detachable plug contact, which allows a simple connection with the counterplug 5 and provides for a safe contact for years.

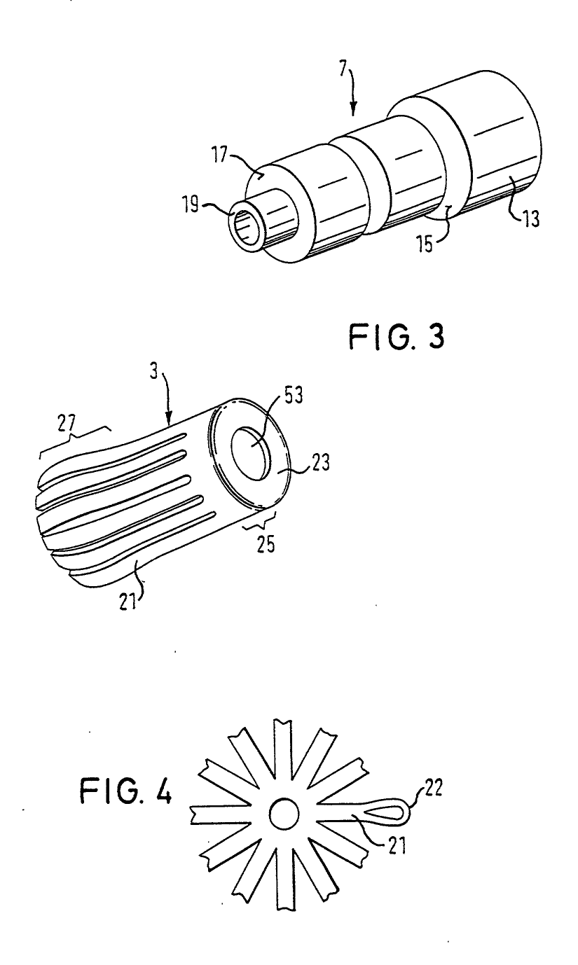

The receptacle 7, which in FIG. 3 is shown in a state not yet pressed and fastened with the plug contact 3, is designed cup-shaped and consists of electric copper material which can be deep-drawn very well. The receptacle 7, however, may also be produced by extrusion. The rearward end of the receptacle 7 has a large diameter cylindrical section 13 into which the electrical conductor 9 is inserted. After insertion, the cylindrical section 13 is permanently fastened to the conductor 9 by crimping, i.e. plastic deformation by applying a radial force. The section 13 continues into a shoulder 15 which forms an axial stop working when the conductor 9 is inserted.

An end wall 17 closes off the receptacle 7 towards the plug contact 3, a protrusion 19 likewise being produced by deep-drawing, this protrusion being axially projecting, hollow and cylindrical, and projecting from the end wall 17.

The plug contact 3 is manufactured from a copper alloy with good elastic properties, by first punching out a sheet metal, as shown in FIG. 4, which has platelets 21 arranged in a star shape.

In the region of their outer ends 22 the platelets 21 are stamped, so that they have a bent free end. The punched and stamped sheet metal is subsequently formed by deep-drawing so as to have the shape shown in FIG. 3, which can be designated as a cup shape. The plug contact 3 comprises an end wall 23, a circumferentially closed, cylindrical section 25 leading off the end wall 23 and an elastic section 27 formed by the platelets 21.

In FIG. 3 there is also to be seen that the free ends are bent radially outwards by stamping and then, towards the free ends, radially inwards and that these platelets complement each other to form a spherical or ball-shaped cap in the stamped region. This region is the region in which a contact takes place with the counterplug 5.

The diameter of the spherical cap and the number of platelets 21 may vary depending on the requirement and embodiment, just as the thickness of the material and the finish of the surfaces which can be coated.

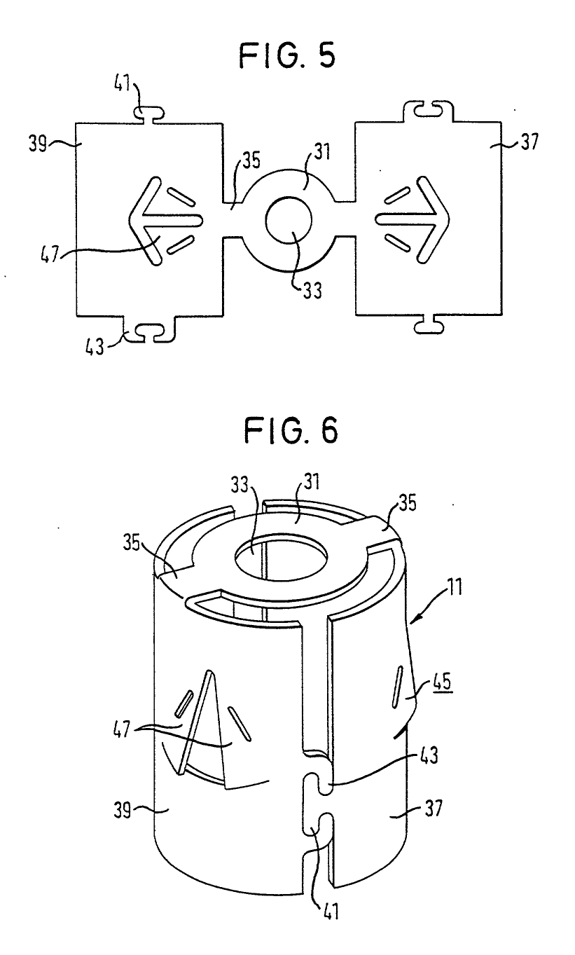

The holding sleeve 11 shown in FIG. 6 is made of an elastic material which, however, can be produced from a more economical material, since there is no current conduction through the holding sleeve 11. The holding sleeve 11 is likewise produced from a punched sheet metal (see FIG. 5) which is then deformed. The holding sleeve 11 has an end wall 31 with a center opening 33, the end wall 31 being fastened to the cylindrical wall consisting of two segments 37, 39 only via two webs 35. The two segments 37, 39 are fastened to each other with an interlocking fit by a mushroom-shaped pin 41 formed on one wall being pushed into a receptacle which is formed by two hook-like sections 43 on the other segment 39. The pin 41 and the sections 43 are clamped to each other by a secondary stamping step.

Each segment 37, 39 has at least one latching device in the form of latching noses 45 which are formed by triangular, bent-out wall sections. These latching noses 45 latch in place, after having plugged the device into the counterplug, in openings 51 in the counterplug 5 and prevent an extraction and decoupling of connection device and counterplug.

The receptacle 7, the plug contact 3 and the holding sleeve 11 are manufactured from differing materials and, therefore, are optimally adapted to their purposes. These three parts are non-detachably fastened with each other by a fastener in the form of a rivet joint, i.e. they can only be disassembled by destruction.

The rivet is formed by the protrusion 19 integrally formed on the end wall 17 and projects through the opening 33 and an opening 53 in the end wall 23 into the interior of the cup-shaped plug contact 3. The protrusion 19 is deformed by a tool which, with respect to FIG. 1, comes from above, the deformed section coming to lie on the upper side of the end wall 23.

The rivet joint exerts a force on the end walls 17, 23 which strives for moving the end walls towards each other, with the consequence that the end wall 31 of the holding sleeve 11 provided between the end walls 17, 23 is axially clamped.

The connection device according to the invention allows a great variability with respect to the shapes of the receptacle 7, the plug contact 3 and the holding sleeve 11, so that a sort of modular system arises.

The holding sleeve is only provided at option and may even be omitted; in that case the end walls 17, 23 would directly adjoin each other instead of an indirect contact as in FIG. 1.

The connection device also allows to be decoupled from the counterplug 5, by the projecting wall sections 45, 47 being pressed radially inwards.

1. An electrical high-current connection device, comprising
a receptacle for an electrical conductor to which conductor said connection device is to be permanently fastened, and
an elastic plug contact for being connected with a counterplug, said receptacle and said plug contact being formed of separate parts which are non-detachably fastened to each other by a fastener.

2. The electrical connection device according to claim 1, wherein said receptacle and said plug contact are made of different materials.

3. The electrical connection device according to claim 1, wherein said receptacle and said plug contact have end walls axially adjoining each other directly or indirectly, and wherein a rivet joint is provided that engages on said end walls and exerts a force on said end walls which strives for moving said end walls towards each other.

4. The electrical connection device according to claim 3, wherein said rivet is a protrusion integrally formed on an end wall and projecting through an opening in said respective other end wall, said rivet being deformed at its free end.

5. The electrical connection device according to claim 4, wherein, in a non-pressed state, said protrusion is hollow and cylindrical and, when pressed, said protrusion being hollow.

6. The electrical connection device according to claim 1, wherein a holding sleeve is provided which has means for latching said connection device in said counterplug to prevent a decoupling of said connection device from said counterplug.

7. The electrical connection device according to claim 1, wherein said holding sleeve is designed as a separate part which is non-detachably fastened to said receptacle and said plug contact by said fastener of said receptacle and said plug contact.

8. The electrical connection device according to claim 7, wherein said holding sleeve is disposed between said end walls of said receptacle and said plug contact and is axially clamped by said end walls.

9. The electrical connection device according to claim 1, wherein at least one of said plug contact and said receptacle are designed to be cup-shaped and are manufactured by one of deep-drawing and extrusion.

10. The electrical connection device according to claim 1, wherein said plug contact is cup-shaped and has platelets which are elastically flexible in a radial direction.

11. The electrical connection device according to claim 10, wherein said platelets have free ends and, in a region of each of said free ends, a section which is bent radially outwards.

12. The electrical connection device according to claim 11, wherein said bent section of said platelets complement each other to form a spherical cap.

13. The electrical connection device according to claim 11, wherein said outwardly bent sections are stamped.
